(19) United States
(12) Patent Application Publication
(10) Pub. No.: US 2013/0117097 A1
(43) Pub. Date: May 9, 2013

(54) ADVERTISING OFFERS USING SOCIAL NETWORKS

(71) Applicant: Michael Bachman, Sunnyvale, CA (US)

(72) Inventor: Michael Bachman, Sunnyvale, CA (US)

(73) Assignee: Google Inc.

(21) Appl. No.: 13/290,723

(22) Filed: Nov. 7, 2011

(51) Int. Cl. G06Q 30/02

(52) U.S. Cl. 705/14.39

(57) ABSTRACT

Systems, methods, and computer-readable media that may be used to present advertisements to a first user based on the first user's interactions with one or more other users are provided. One method includes transmitting an electronic advertisement to a user computing device. The electronic advertisement includes an invitation for the user to receive a non-cash benefit in return for allowing an advertiser associated with the electronic advertisement access to one or more aspects of an account of the user on a social network. The method further includes receiving an indication that the user has accepted the invitation for the non-cash benefit, performing an action on behalf of the advertiser relating to the account of the user on the social network and providing a confirmation message to the user indicating that the non-cash benefit will be provided.

### BACKGROUND

The Internet provides access to a wide variety of content. Advertisements can be provided along with requested content. Advertisements can be targeted to viewers of content. For instance, ads can be selected based upon a user's search terms entered into a search engine. Such targeting helps provide relevant advertisements to users. Providing relevant advertisements to users typically provides an increase in click through rates and better exposure for an advertiser. Typical electronic advertisements are directed to one-to-one engagement between the user and the advertiser without any implications relating to contacts that the user may have with other users.

### SUMMARY

One implementation of the disclosure relates to a method executing on one or more computing devices. The method includes transmitting, using the one or more computing devices, an electronic advertisement to a user computing device. The electronic advertisement includes an invitation for the user to receive a non-cash benefit in return for allowing an advertiser associated with the electronic advertisement to utilize one or more aspects of an account of the user on a social network for the benefit of the advertiser. The social network includes a service on which the user can post messages. The social network includes accounts for each of one or more co-users, and the user's account is connected to the accounts of the one or more co-users of the social network. The method further includes receiving, using the one or more computing devices, an indication that the user has accepted the invitation for the non-cash benefit. The method further includes, in response to receiving the indication, performing an action on behalf of the advertiser relating to the account of the user on the social network and providing a confirmation message to the user indicating that the non-cash benefit will be provided.

Another implementation of the disclosure relates to an apparatus comprising at least one computing device operably coupled to at least one memory and configured to transmit an electronic advertisement to a user computing device. The electronic advertisement includes an invitation for the user to receive a non-cash benefit in return for allowing an advertiser associated with the electronic advertisement to utilize one or more aspects of an account of the user on a social network for the benefit of the advertiser. The social network includes a service on which the user can post messages. The social network includes accounts for each of one or more co-users and the user's account is connected to the accounts of the one or more co-users of the social network. The at least one computing device is further configured to receive an indication that the user has accepted the invitation for the non-cash benefit. The at least one computing device is further configured to, in response to receiving the indication, perform an action on behalf of the advertiser relating to the account of the user on the social network and transmit data to the user computing device that is configured to provide the user with access to the non-cash benefit.

Yet another implementation of the disclosure relates to a computer-readable medium having instructions stored thereon that, when executed by a processor, cause the processor to perform operations including transmitting an electronic advertisement to a user computing device. The electronic advertisement includes an invitation for the user to receive a non-cash benefit in return for allowing an advertiser associated with the electronic advertisement to utilize one or more aspects of an account of the user on a social network for the benefit of the advertiser. The social network includes a service on which the user can post messages. The social network includes accounts for each of one or more co-users, and the user's account is connected to the accounts of the one or more co-users of the social network. The operations further include receiving an indication that the user has accepted the invitation for the non-cash benefit. The operations further include, in response to receiving the indication, performing an action on behalf of the advertiser relating to the account of the user on the social network and transmitting data to the user computing device that is configured to provide the user with access to the non-cash benefit.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is a block diagram of an example environment in which advertisements may be provided to users according to an illustrative implementation.

FIG. 2 is a data flow diagram illustrating data flow through a system configured to provide social network-based advertising offers to users according to an illustrative implementation.

FIG. 3 is a flow diagram of a process for providing social network-based advertising offers to users according to an illustrative implementation.

FIGS. 4 through 6 are example advertisement display images that may be displayed to a user in association with providing a social network-based advertising offer to the user according to illustrative implementations.

FIG. 7 is a flow diagram of a process for performing an action on behalf of an advertiser where the action includes transmitting data configured to cause a message to be posted on an account of a user on a social network according to an illustrative implementation.

FIG. 8 is a block diagram of a computing system according to an illustrative implementation.

### DETAILED DESCRIPTION

### Overview

Referring generally to the Figures, various illustrative systems and methods are provided that may be used to leverage users' social networks by providing users with a benefit, such as a coupon, in exchange for access to their social networks. Typical online ads are mainly focused around users downloading applications, visiting advertiser sites, Click-to-Call, expanding a map for directions, etc. Such interactions are purely on a 1:1 engagement between the user and the advertiser without any social implications. In some embodiments, the user can opt out of receiving any such advertisements or offers. Users may also opt out of receiving advertisements from such referral systems. In some embodiments, the users have to opt into receiving such advertisements in order for the advertiser to receive their information via referrals.

The present disclosure describes various methods and features for generating advertisements that offer a benefit to users (e.g., a non-cash benefit, such as an exclusive coupon) in exchange for allowing advertisers to gain access to certain aspects of the users' accounts on social networks. The advertisers may use the advertising system to set up an ad for display to users. The ad may present an option to the users to share the ad (or another ad associated with the advertiser) via a social network, such as Google+. If the user opts to share the ad using the user's social network (e.g., by clicking a Google+, g+, +1, Like, etc. symbol in the ad), the ad may be altered (e.g., by changing the ad displayed in the window, by expanding the displayed information, by popping up a new window, by sending the user to a new webpage, etc.) to provide the user with access to the benefit.

In some implementations, by consenting to sharing his social network, a user may give the advertiser access to a list of the user's contacts on the social network. In some implementations, a user may consent to posting a message on the user's social network account relating to the advertisement and/or advertiser. In some such embodiments, other co-users that subsequently interact with the post (e.g., in Google+, by clicking +1 on the post or re-sharing the post) on the user's social network profile (e.g., on the user's Google+ stream) may be added to a list of people interested in the ad that is made accessible to the advertiser. Some implementations may make the benefit provided to the initial user based on parameters of the social network. For example, the user may receive a greater benefit if the user has a large number of contacts/friends on the social network than if the user has a smaller number of contacts, or the benefit provided may be variable based on the number of contacts who subsequently interact with the user's post.

Various illustrative implementations of advertisement systems may provide various benefits to advertisers and/or users. For example, offers (e.g., presented via Google Offers) may be seamlessly integrated with other advertising content. Information regarding social network users who may be interested in particular types of advertising content can be obtained based on the users interacting with the advertising content on the social network. For example, information regarding users who share, re-share, “+1”, etc. advertisement-related posts and/or messages may be collected and used to develop user lists to whom later advertisement campaigns may be directed. Billing may be provided on a call-to-action basis (e.g., based on users' interactions with the advertising content) as opposed to, for example, billing based on the number of impressions or click-throughs for an advertisement.

Various terms utilized in the present disclosure are intended to be given their plain and ordinary meanings unless otherwise indicated. For example, the phrase social network, as used herein, encompasses its plain and ordinary meaning, including, but not limited to, any service (e.g., online messaging service) through which users can interact with one another, for example, by posting messages and/or other information that may be viewed by one or more other users of the service. The phrase co-users, as used herein, encompasses its plain and ordinary meaning, including, but not limited to, individuals who use a social network to interact with a user of the social network. The phrase electronic advertisement, as used herein, encompasses its plain and ordinary meaning, including, but not limited to, content displayed to a user on a computing device of a user that is provided to the user in an electronic format (e.g., using a computing or other communication network).

### Illustrative Advertising System Environment

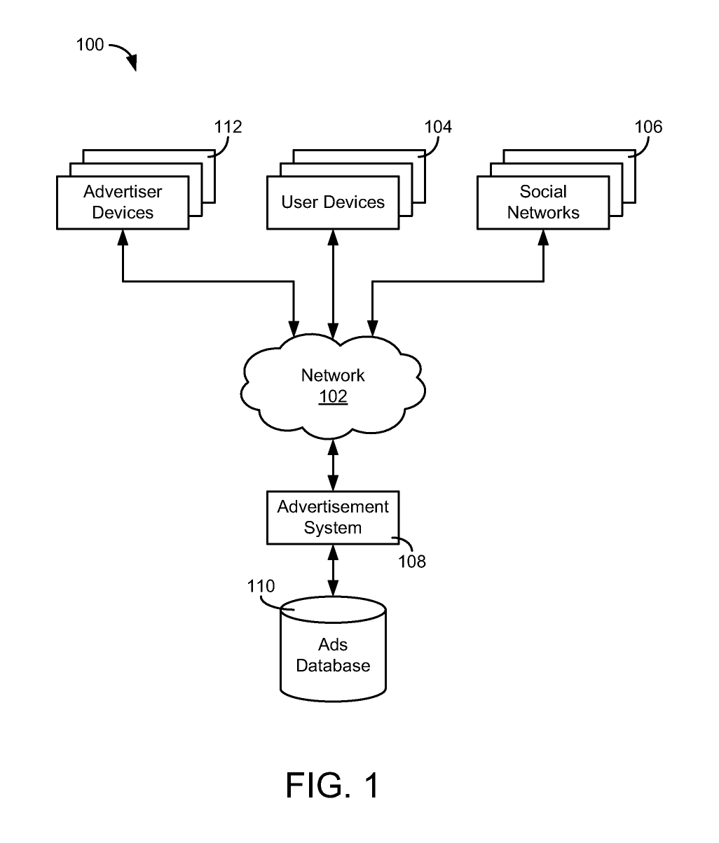

Referring to FIG. 1, a block diagram of an example environment 100 in which advertisements may be provided to users is shown according to an illustrative implementation. One or more user devices 104 may be used by a user to access various types of content, some of which may be provided over a network 102 (e.g., the Internet, LAN, WAN, etc.). For example, user devices 104 may be used to access websites (e.g., using an internet browser such as Google Chrome), media files, and/or any other types of content. In some instances, the content may include and/or be accompanied by advertising content. Some such advertising content may be interactive, such that a user may click on or otherwise interact with the advertisement to perform an action, such as visiting a website of the advertiser, downloading an application, calling a phone number, opening an application on the user device 104 of the user, expanding or opening a map of a location, opening a navigation application to navigate to a location, etc.

User device 104 may be any type of computing device (e.g., having one or more processors and/or memories or other types of computer-readable media), such as a television and/or set-top box with one or more processors embedded therein or coupled thereto, mobile communication device (e.g., cellular telephone, smartphone, etc.), computer and/or media device (desktop computer, laptop or notebook computer, netbook computer, tablet device, gaming system, etc.), or any other type of computing device. In some implementations, one or more user devices 104 may be set-top boxes or other devices for use with a television set, such as a Google TV device. In some implementations, content may be provided via a web-based application and/or an application resident on a user device 104. In some implementations, user devices 104 may be designed to use various types of software and/or operating systems, such as the Google Android operating system. In various illustrative implementations, user devices 104 may be equipped with and/or associated with one or more user input devices (e.g., keyboard, mouse, remote control, touchscreen, etc.) and/or one or more display devices (e.g., television, monitor, CRT, plasma, LCD, LED, touchscreen, etc.).

User devices 104 may be configured to receive data and/or programming from various sources using a network 102. In some implementations, network 102 may comprise a computing network (e.g., LAN, WAN, Internet, etc.) to which user devices 104 may be connected via any type of network connection (e.g., wired, such as Ethernet, phone line, power line, etc., or wireless, such as WiFi, WiMAX, 3G, 4G, satellite, etc.). In some implementations, network 102 may additionally or alternatively comprise a media distribution network, such as cable (e.g., coaxial metal cable), satellite, fiber optic, etc., configured to distribute media programming and/or data content.

In various illustrative implementations, an advertisement system 108 may be configured to determine advertisements to provide to various user devices 104 under various circumstances and/or based on various parameters. Advertisement system 108 may be configured to determine the advertisements to provide to users based on advertiser input provided using one or more advertiser devices 112. Advertisers may provide advertising content, such as the actual advertisements that are to be displayed, and/or parameters used to determine when certain advertisements are displayed (e.g., characteristics of users to whom the advertisements are displayed, characteristics of types of websites and/or surrounding content on a webpage on which the advertisements are displayed, etc.). Advertisement system 108 may be configured to store ad content and/or parameters in an ads database 110.

In some implementations, advertisements may be provided that are primarily based on a 1:1 engagement between the advertiser and the user. For example, as user may navigate to a particular website and be presented with an advertisement (e.g., call-to-action display advertisement, text advertisement, video advertisement, etc.) that may be configured to perform an action in response to the user interacting with the advertisement (e.g., clicking, hovering a mouse pointer, etc.). The action may include, for example, visiting a website of the advertiser, downloading an application, calling a phone number, opening an application on the user device 104 of the user, expanding or opening a map of a location, opening a navigation application to navigate to a location, etc.

In some implementations, a social context may be added within an advertisement. For example, a button or other input field may be added to an advertisement that is linked to an account of a user on a social network 106. Social networks 106 may include any type of messaging services configured to allow users to post messages (e.g., textual, picture, video, links to web addresses and/or media posted on the Internet, etc.) and may include, for example, Google+, Facebook, Twitter, LinkedIn, MySpace, Buzz, Orkut, Bebo, etc. Users may be identified on social networks 106 by legal name and/or by a username (e.g., unique from other users of the respective social network 106) or other user identifier such as a profile photograph. In some implementations, all messages posted on a social network 106 may be publicly accessible. In other implementations, some or all of the messages posted on a social network 106 may be limited in their publicity or distribution (e.g., private, semi-private), such that only particular types of groups (e.g., friends, co-workers, acquaintances, schoolmates, etc.), particular identified users, etc. can access particular messages or groups of messages. In some implementations, users may provide credentials (e.g., a username or email address and a password) via user device 104 used to authenticate the user and provide user device 104 with access to content (e.g., messages) that may not be publicly accessible but may be accessible by the user.

In some implementations, by clicking a button or other input field linked to the user's account on a social network 106, the user may perform an action with respect to the user's account. For example, a user may click a “+1” icon linked to the user's account on Google+, and the advertisement may be shared with other co-users or contacts of the user on Google+. In some implementations, clicking on the advertisement may lead to a separate advertiser landing page. In some such implementations, it may be difficult to return to the advertisement to interact with the social component of the advertisement after reaching the landing page, particularly if the previous page is reloaded, because advertisements are often changed after the page is reloaded (unless, for example, the advertisement is based on a particular day-part reservation, where the advertisement will continue to appear to all visitors of the page for a reserved portion of a day).

Social networks 106 may be sources of very useful information and/or exposure for advertisers. For example, an advertiser may be able to present a user with more relevant or interesting advertisements if the advertiser is able to obtain interest data, demographic data, and/or other information about the user that may be stored and/or posted as part of the user's account on one or more social networks 106. Additionally, social networks 106 may provide tools for connecting with other co-users, such as friends or contacts, with whom the user interacts on the social networks 106. For example, users may post information and/or messages on social networks 106 that may be viewed by other co-users. In this manner, the advertiser may reach a wide variety of other users through the user's account on the social network 106, some of whom may share common interests with the user and may be likely to show interest in the advertisement. In some implementations, advertisers may be able to use information about other co-users' interactions with an advertisement-related post of the user on a social network 106 to determine appropriate advertisements that may be presented to the other co-users.

Advertisement system 108 may be configured to enable advertisers leverage one or more aspects of a user's account(s) on one or more social networks 106 in exchange for providing the user with a benefit (e.g., a non-cash benefit). For example, in some implementations, an advertiser may use advertisement system 108 (e.g., via an advertiser device 112) to set up a new interactive advertisement through which the advertiser is offering the user a coupon for forty percent off of a particular product in exchange for the user sharing an advertisement relating to the advertiser and/or product though a message on the user's account on a social network 106. In some implementations, the message may include a link to the same social network-based advertising deal offered to the user. Once the user has taken the steps necessary to post of the message on the user's social network account, the user may be provided with access to the coupon (e.g., by a new display image being presented to the user with a printable coupon or coupon code, by an email being sent to the user's email address, etc.).

In various illustrative implementations, the benefits offered to users may be any or all of a variety of different types of benefits. For example, users may be offered discounts on products or services provided by the advertiser or another entity. In another example, users may be offered access to exclusive products, services, and/or information to which the users did not previously have access. In some implementations, users may be enabled to download applications, media files, and/or other content in exchange for allowing access to aspects of their user accounts. In another example, users may be credited with points in a rewards program offered by the advertiser (e.g., that may be redeemed for goods/services once enough points are accumulated). In another example, a user may be provided with a cash benefit, such as by a transfer of money into an account of the user, a check sent to a mailing address of the user, etc.

In various illustrative implementations, advertisers may use advertisement system 108 to generate advertisements configured to provide access to a variety of aspects of users' accounts on social networks 106. For example, in one implementation, a user may consent to sharing with the advertiser information posted on the user's account on a social network in exchange for receiving a benefit. Such information may include, for example, profile information (e.g., employment information, education information, marital status information, birth date, interests such as music, books, movies, television shows, etc., activities, contact information such as email and/or physical address and/or geographic location, etc.), lists or friends or contacts on the social network, messages posted by the user and/or co-users in relation to the user's account on the social network, etc. This information may be stored in a database by advertisement system 108 and made accessible to the advertiser.

In some illustrative implementations, a user may post a message (e.g., including advertising content) relating to the advertiser and/or product/service being promoted on the social network in exchange for receiving a benefit. For example, an advertisement may be configured to present the user with an interface that provides an offer to the user to receive a benefit in exchange for sharing the advertisement on a social network. The advertisement may be configured to provide an interface that the user may use to provide input needed to post the message on the user's social network account (e.g., on a “Stream” or user profile on Google+). In some implementations, the user may already be logged into the account on the social network, and the advertisement may be configured to determine that the user has already been logged in and post the message in response to the user providing input indicating consent of the user to post the message (e.g., by clicking a “Share” button). In some implementations, the advertisement may be configured to forward the user to a login interface for the social network before the user is provided with the consent interface.

In some illustrative implementations, advertisement system 108 may be configured to receive and/or collect information relating to users that interact with a posted message relating to an advertisement. For example, advertisement system 108 may be configured to receive a list of other co-users who have indicated approval in relation to the message (e.g., by clicking “+1” with respect to the message on Google+). In another example, advertisement system 108 may be configured to receive a list of co-users who have re-posted or shared the message using their own user accounts on the social network. In some implementations, some or all of the co-users who have interacted with the posted message may be extended a benefit as well. In some implementations, the co-users may be provided a benefit solely based on sharing the advertising content or message in some manner (e.g., in Google+, by clicking “+1” on the message, by sharing or re-posting on their streams, etc.). In other implementations, the co-users may be provided a benefit in exchange for performing some further action. For example, if the co-user is presented with an advertising interface in response to the co-user clicking “+1”, the advertisement may offer a benefit in exchange for the co-user posting a more detailed message or re-sharing on the co-user's stream, or in exchange for the co-user sharing one or more aspects of the co-user's profile on the social network with the advertiser.

In some illustrative implementations, the benefit provided to the user may be based at least in part on the aspects of the user's social network account to which the advertiser is granted access. In some implementations, the benefit provided to a user may depend upon how many friends or contacts the user has on the social network. For example, a first user having 830 friends on a social network may be offered a sixty percent discount on a product, and a second user having 55 contacts on the social network may be offered a twenty percent discount on the product. In some implementations, when a benefit is provided in exchange for a user posting a message on the social network using the user's account, the benefit provided may depend upon how many co-users interact with the posted message (e.g., by viewing the posted message, by clicking through a link associated with the posted message to an advertiser website, by clicking “+1” or otherwise indicating approval of the message, by reposting or sharing the message, by purchasing a product/service associated with the advertisement, etc.). For example, a first user having 150 co-users indicate approval (e.g., via a “+1” button) of a posted advertising message may be provided with a sixty percent discount on a product, and a second user having 20 co-users indicate approval of a posted advertising message may be provided with a twenty percent discount on the product. In various illustrative implementations, advertisement system 108 may be configured to provide advertisers with a setup interface (e.g., via advertiser devices 112) that the advertisers may be use customize various aspects of the advertisements, including, in some implementations, conditions associated with the benefits that are provided to users in exchange for receiving various levels of access to aspects of the users' accounts on social networks 106.

### Illustrative Social Offer Data Flow

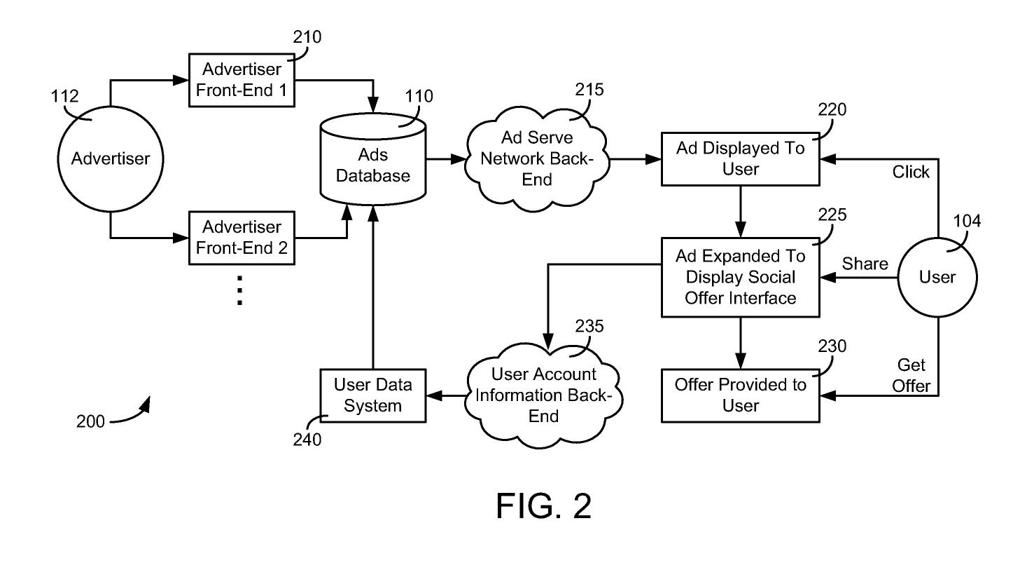

Referring now to FIG. 2, a data flow diagram 200 illustrating data flow through a system configured to provide social network-based advertising offers to users is shown according to an illustrative implementation. In some implementations, various steps and/or components shown in FIG. 2 may include or be carried out using components of environment 100 shown in FIG. 1.

An example advertisement may be originated by an advertiser (e.g., using an advertiser device 112) using one or more advertiser front-end interfaces 210. Advertiser front-end interfaces 210 may include user interfaces that may be provided by advertisement system 108 to advertisers (e.g., via network 102) and that may be used by the advertisers to generate advertisements. For example, the advertiser may specify the type of advertisement or interaction result (e.g., application download, click-to-call, dynamic or static ads, etc.), parameters such as benefit conditions and benefit type, art for the advertisement, landing page, call-to-action bid (e.g., a bid or monetary amount the advertiser is willing to pay for each user action associated with the advertisement), geo-targeting and/or time targeting (e.g., particular geographic areas and/or times with which the advertisement should be associated), etc. In one illustrative implementation, advertiser front-end interfaces 210 may include a Google Offers front-end interface and/or a Google AdWords front-end interface. The created advertisement may be saved in ads database 110.

The advertisement may be presented to users through one or more ad serve network back-end systems 215 configured to provide advertisements to users based on certain predetermined conditions (e.g., provided by the advertisers) (220). A presented advertisement may include an offer for a user to receive a benefit in exchange for providing the advertiser with access to aspects of the user's account on a social network. For example, in some implementations, the user may receive a benefit for sharing the advertisement over a social network by posting a message using the user's account on the social network. In some implementations, the user may click a portion of the advertisement to open an expanded view of a social offer interface that the user can use to share the message on the social network (225). Once the user has used the interface to share the advertisement, another interface may be provided to the user that is configured to provide the user with access to the benefit (230). In some implementations, a coupon code or other access tool may be provided to the user in the new interface. In some implementations, the user may be notified that information needed to access the benefit, or the benefit itself, is being provided in another way (e.g., via email, via physical mail, etc.). In some implementations, the new interface may request information used to provide the benefit information, such as physical mailing address or email address.

Information to which the user has consented to provide the advertiser access regarding the user's account on the social network may be collected using a user account information back-end system 235. The information may be stored in a user data system 240. User data system 240 may be used to generate lists of users to whom certain advertisements may be targeted. In some implementations, the lists may include various characteristics of the users, such as interest information, that may be useful in determining users to whom certain types of advertisements should be targeted.

### Illustrative Process for Providing Social Offers

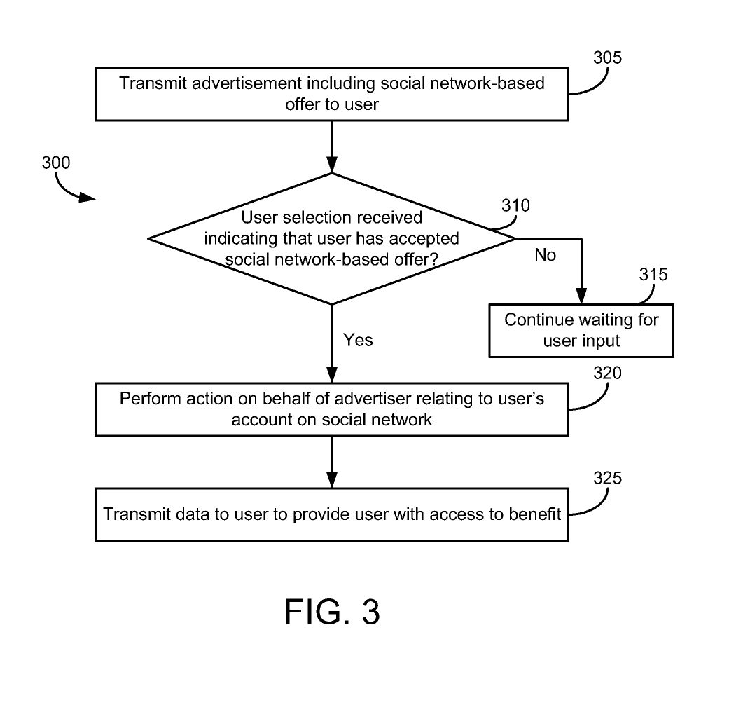

Referring now to FIG. 3, a flow diagram of a process 300 for providing social network-based advertising offers to users is shown according to an illustrative implementation. In some illustrative implementations, process 300 may be carried out using various components shown in and/or described with respect to FIGS. 1 and/or 2.

An advertisement system may be configured to transmit an advertisement including a social offer to a user (305). In various illustrative implementations, the advertisement may be provided to the user in response to any number of different user actions, such as visiting a particular website or web page, viewing a particular type of media content, searching for a particular word or phrase in a search engine, and/or any other type of action (e.g., online action). The social offer included in the advertisement may be an offer to provide a benefit (e.g., a non-cash benefit, such as a coupon or discount) to the user in exchange for the consent of the user to share one or more aspects of the user's profile on a social network. In some implementations, an interface may be displayed (e.g., upon the user selecting a portion of the advertisement) that provides the user with fields for entering social network information (e.g., account information, message posting information, confirmation that the user wishes to share the advertisement, etc.).

The advertisement system may be configured to wait to receive an indication of user input provided by the user with respect to the advertisement (e.g., by clicking or otherwise selecting a portion of the advertisement) (310). If a user selection is not received indicating that the user has accepted the social offer, the advertisement system may continue to wait to receive such input (e.g., until input is received indicating that the user has declined the offer, the user has navigated away from the webpage on which the advertisement was displayed, the displayed advertisement has changed, for example based on the passage of a predetermined amount of time, etc.) (315).

If a user selection is received indicating that the user has accepted the social offer, an action may be performed on behalf of the advertiser relating to the user's account on the social network (320). In various implementations, the action may include collecting information relating to the user's account (e.g., demographic information, interest information, list of contacts on the social network, etc.) and/or transmitting data that causes messages or information to be displayed on the social network in relation to the user's account (e.g., a message relating to the advertisement, such as a link to a webpage that may be reached by clicking through the advertisement). In some implementations, the action may include collecting information about other co-users on the social network who interact with a posted message and/or taking further actions with respect to those co-users (e.g., providing a social offer to the co-users).

The advertisement system may be configured to transmit data to provide the user with access to the benefit (325). In some implementations, at least a portion of the advertisement may be modified to provide the user with information needed to access the benefit. For example, a coupon code may be provided or a printable coupon may be displayed that the user can redeem for a discount on a product/service. In another example, an interface may be provided for the user to enter information used to provide the benefit, such as an email address or mailing address to which a coupon or product may be sent. In another example (e.g., when the benefit includes access to an application, media file, website, etc. to which the user did not previously have access), a link may be provided (e.g., in the advertisement or via another method such as email or text message) that can be used to access certain content (e.g., content having restricted access). In some implementations, the transmitted data may provide the user with access to the benefit by notifying the user that the benefit is being provided in some other manner, such as to an email address of the user, by text message or another method to a mobile device of the user, by physical mail to a mailing address of the user, etc.

### Illustrative Social Offer Display Images

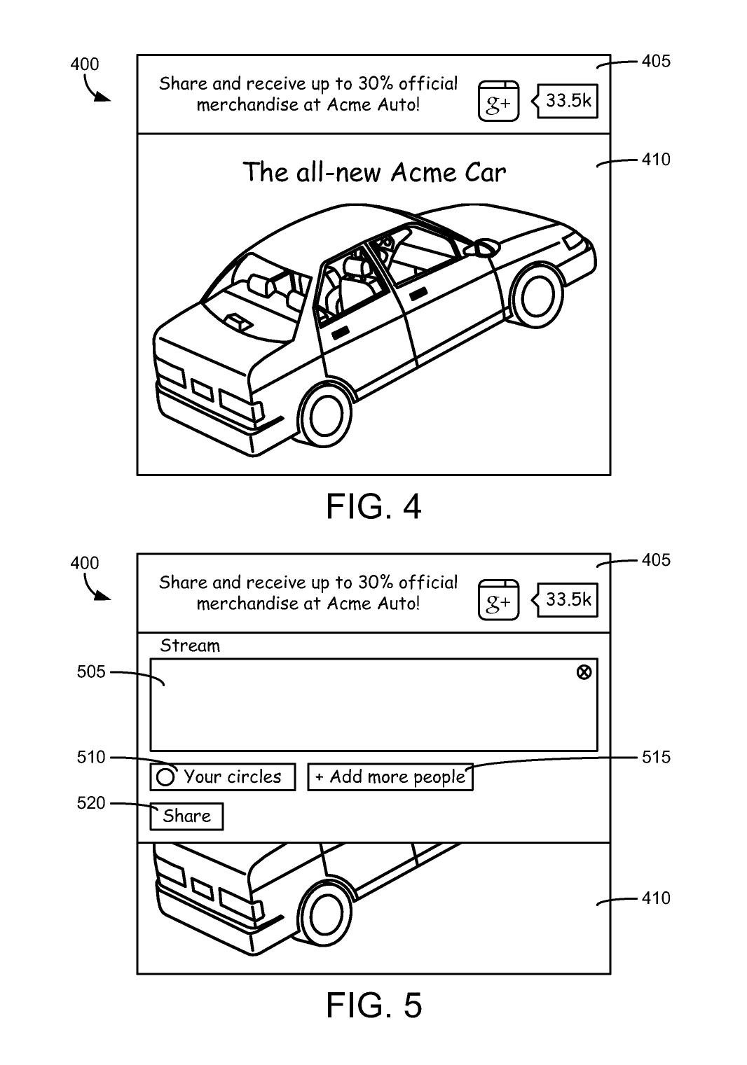

FIGS. 4 through 6 illustrate example advertisement display images that may be displayed to a user in association with providing a social network-based advertising offer to the user according to illustrative implementations. In some implementations, the display images may be presented using various components and features shown in and described with respect to FIGS. 1 through 3. For example, data representing the display images may be transmitted from advertisement system 108 to a user device 104.

FIG. 4 illustrates a display image 400 that may be displayed to a user, for example, upon viewing an offer on Google Offers. In various illustrative implementations, an image similar to display image 400 may be displayed when the user performs a variety of other types of actions, such as visiting a website, performing a search engine search (e.g., a Google search), viewing or listening to media content, etc. Display image 400 includes a product frame 410 in which a product to which the advertisement is directed is displayed. In the illustrated implementation, the product is the “Acme Car” sold by “Acme Auto.” Display image 400 also includes a social offer frame 405 in which information is provided regarding an offer from the advertiser to provide a benefit to the user in exchange for the user granting access to the advertiser to one or more aspects of the user's account on a social network. In the illustrated implementation, Acme Auto is offering the user thirty percent off of official merchandise in exchange for the user sharing the advertisement by posting a message on Google+ using the user's Google+ account.

FIG. 5 shows display image 400 as it may appear when a user clicks on social offer frame 405 according to an illustrative implementation. In response to the user clicking on social offer frame 405, an expanded social offer interface may be provided to the user. The expanded interface includes a message box 505 in which the user may enter a personalized message to accompany the advertisement-related post on the user's Google+ Stream. The expanded interface also includes a group selection input 510 that allows the user to select one or more groups of contacts (e.g., circles on Google+, such as friends, work colleagues, acquaintances, family, etc.) with whom the user wishes to share the advertisement-related post. The expanded interface also includes a user addition input 515 that allows the user to individually add other co-users to whom the advertisement-related message should be directed. In some implementations, the benefit provided to the user may vary based on the number or proportion of co-users with whom the user shares the advertisement-related message. For example, in one implementation, Acme Auto may offer to increase the discount to forty percent if the user shares the message with all of the user's circles on Google+ and may offer only a twenty percent discount if the user only shares the message with one small circle. In another example, Acme Auto may offer a forty percent discount if the user shares the message with 500 contacts and only a twenty percent discount if the user only shares the message with 15 contacts. Various settings such as these customized discounts may be provided to the advertisement system by the advertiser when the advertiser is setting up the advertisement. The user may provide approval to share the message and consent to the offer by clicking the share button 520.

FIG. 6 shows display image 400 as it may appear after the user clicks share button 520 and approves the offered deal according to an illustrative implementation. Display image 400 is modified to display a benefit information frame 605 configured to convey information regarding the benefit to the user. In the illustrated implementation, the user is provided with a coupon code that can be used to redeem the thirty percent discount at Acme Auto. Benefit information frame 605 also provides the address of Acme Auto to the user. In some illustrative implementations, benefit information frame 605 may not directly provide a coupon code or other offer redemption tool but instead may inform the user that the benefit is being delivered in some other manner (e.g., via email, physical mail, etc.). In one example, benefit information frame 605 may inform the user that Acme Auto has been notified of the transaction and that the user can visit Acme Auto and redeem the discount by asking an employee to look up the benefit in the Acme Auto computing system.

### Illustrative Process for Performing an Action Including Posting a Message on a User's Social Network Account

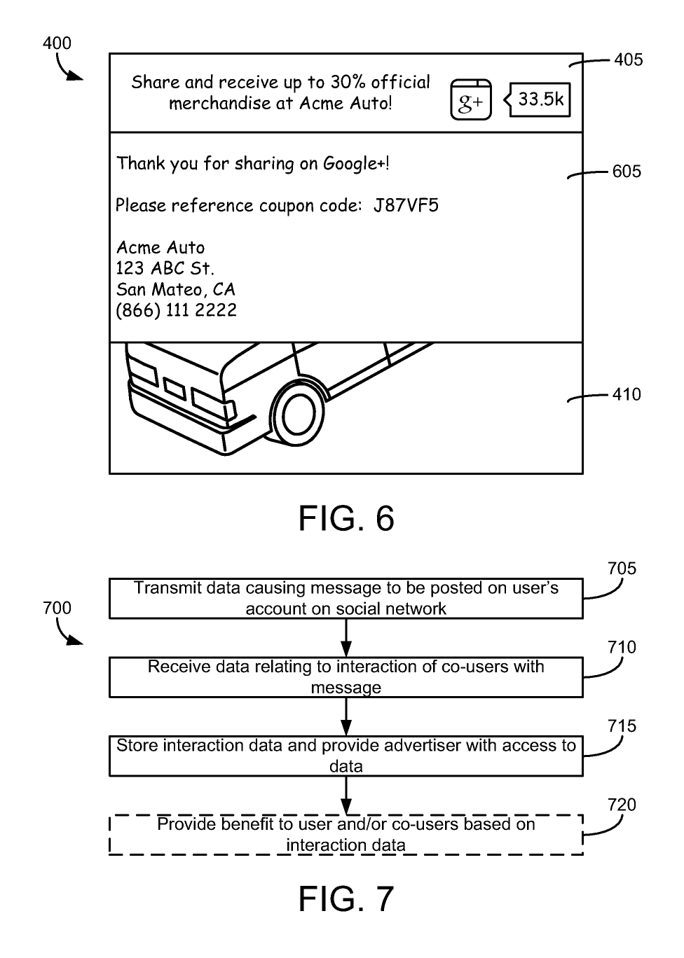

FIG. 7 illustrates a flow diagram of a process 700 for performing an action on behalf of an advertiser where the action includes transmitting data configured to cause a message to be posted on an account of a user on a social network according to an illustrative implementation. In some illustrative implementations, process 700 may be carried out using various components shown in and/or described with respect to FIGS. 1 and/or 2. In some illustrative implementations, process 700 may be performed in conjunction with and/or as a part of one or more features of process 300 described with respect to FIG. 3. For example, in some implementations, process 700 may be a part of the action performed on behalf of the advertiser (see ref. no. 320 of process 300).

After receiving consent from a user, an advertisement system may be configured to transmit data to the appropriate social network responsive to which a message may be posted on the user's account on the social network (705). In some implementations, the user may already be authenticated with the social network in a particular browser session and the message may be identified as being associated with the user account without the user being required to enter authentication information again. In some implementations, the user may be asked to authenticate the user's identity with the social network before the message-related data can be sent to the social network.

In some implementations, the social network may permit other co-users to interact with the posted message, and the advertisement system may be configured to receive information relating to the interaction of the co-users with the message. For example, on Google+, co-users may indicate approval of the advertisement-related message by clicking “+1” next to the posted message. In some implementations, the advertisement system may receive a list of users who have clicked “+1” in relation to the message. The interaction data may be stored in a memory (e.g., a database) and shared with the advertiser (e.g., via a website, via reports provided to the advertiser, etc.) (715). In some implementations, the social network and/or advertisement system may be configured to ask permission of users before providing the information to the advertiser.

In some implementations, the advertisement system may be configured to provide and/or modify a benefit to the original user and/or other co-users who interacted with the posted message based on the interaction data (720). In some implementations, the benefit provided to the original user who posted the original message may be based upon the interaction data. For example, a discount or number of rewards points provided to the user may be larger if 150 users clicked “+1” or re-shared the post than if only ten users clicked “+1” or re-shared the post. In some implementations, the benefit may be offered to other co-users who indicate approval of the posted message (e.g., by clicking “+1”). In some implementations, the benefit may only be offered to co-users who re-share the offer by posting a separate message under the co-users' accounts. By providing benefits to other co-users who interact with previously posted messages, exposure of the advertisement may cascade through multiple generations of posted and re-posted messages. In some implementations, information about each of the co-users that interact with the posted messages and/or re-share the messages may be collected by the advertisement system and/or may be shared with the advertiser.

### Illustrative Computer System

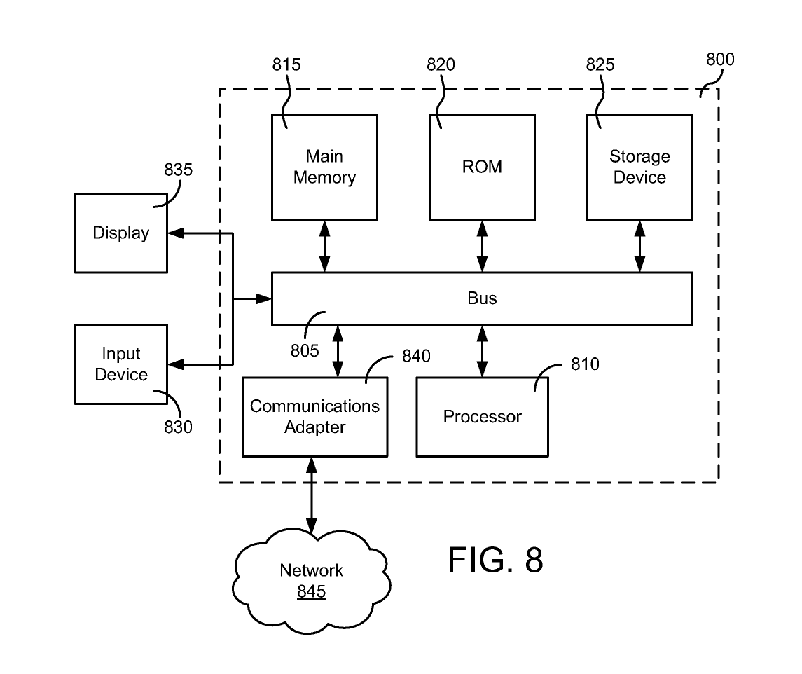

FIG. 8 illustrates a depiction of a computer system 800 that can be used, for example, to implement an illustrative user device 104, an illustrative advertisement system 108, and/or various other illustrative systems that may be used in the provision of social network-based advertisements as described in the present disclosure. The computing system 800 includes a bus 805 or other communication component for communicating information and a processor 810 coupled to the bus 805 for processing information. The computing system 800 also includes main memory 815, such as a random access memory (RAM) or other dynamic storage device, coupled to the bus 805 for storing information, and instructions to be executed by the processor 810. Main memory 815 can also be used for storing position information, temporary variables, or other intermediate information during execution of instructions by the processor 810. The computing system 800 may further include a read only memory (ROM) 810 or other static storage device coupled to the bus 805 for storing static information and instructions for the processor 810. A storage device 825, such as a solid state device, magnetic disk or optical disk, is coupled to the bus 805 for persistently storing information and instructions.

The computing system 800 may be coupled via the bus 805 to a display 835, such as a liquid crystal display, or active matrix display, for displaying information to a user. An input device 830, such as a keyboard including alphanumeric and other keys, may be coupled to the bus 805 for communicating information, and command selections to the processor 810. In another implementation, the input device 830 has a touch screen display 835. The input device 830 can include a cursor control, such as a mouse, a trackball, or cursor direction keys, for communicating direction information and command selections to the processor 810 and for controlling cursor movement on the display 835.

In some implementations, the computing system 800 may include a communications adapter 840, such as a networking adapter. Communications adapter 840 may be coupled to bus 805 and may be configured to enable communications with a computing or communications network 845 and/or other computing systems. In various illustrative implementations, any type of networking configuration may be achieved using communications adapter 840, such as wired (e.g., via Ethernet), wireless (e.g., via WiFi, Bluetooth, etc.), pre-configured, ad-hoc, LAN, WAN, etc.

According to various implementations, the processes that effectuate illustrative implementations that are described herein can be achieved by the computing system 800 in response to the processor 810 executing an arrangement of instructions contained in main memory 815. Such instructions can be read into main memory 815 from another computer-readable medium, such as the storage device 825. Execution of the arrangement of instructions contained in main memory 815 causes the computing system 800 to perform the illustrative processes described herein. One or more processors in a multi-processing arrangement may also be employed to execute the instructions contained in main memory 815. In alternative implementations, hard-wired circuitry may be used in place of or in combination with software instructions to implement illustrative implementations. Thus, implementations are not limited to any specific combination of hardware circuitry and software.

Although an example processing system has been described in FIG. 8, implementations of the subject matter and the functional operations described in this specification can be carried out using other types of digital electronic circuitry, or in computer software, firmware, or hardware, including the structures disclosed in this specification and their structural equivalents, or in combinations of one or more of them.

Implementations of the subject matter and the operations described in this specification can be carried out using digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be implemented as operations performed by a data processing apparatus on data stored on one or more computer-readable storage devices or received from other sources.

The term “data processing apparatus” or “computing device” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be carried out using a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be carried out using a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

In some illustrative implementations, the features disclosed herein may be implemented on a smart television module (or connected television module, hybrid television module, etc.), which may include a processing circuit configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services (e.g., Netflix, Vudu, Hulu, etc.), a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate embodiments, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be carried out in combination in a single implementation. Conversely, various features that are described in the context of a single implementation can also be carried out in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Additionally, features described with respect to particular headings may be utilized with respect to and/or in combination with illustrative implementations described under other headings; headings, where provided, are included solely for the purposes of readability and should not be construed as limiting any features provided with respect to such headings.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A method executing on one or more computing devices, the method comprising:
transmitting, using the one or more computing devices, an electronic advertisement to a user computing device, wherein the electronic advertisement includes an invitation for the user to receive a non-cash benefit in return for allowing an advertiser associated with the electronic advertisement to utilize one or more aspects of an account of the user on a social network for the benefit of the advertiser, wherein the social network comprises a service on which the user can post messages, and wherein the social network comprises accounts for each of one or more co-users and the user's account is connected to the accounts of the one or more co-users of the social network;
receiving, using the one or more computing devices, an indication that the user has accepted the invitation for the non-cash benefit;
in response to receiving the indication, performing one or more actions on behalf of the advertiser relating to the account of the user on the social network, wherein the one or more actions comprise causing a message to be posted on a web page of the account of the user on the social network, the message being related to at least one of the advertisement or the advertiser;
determining, using the one or more computing devices, a value for the non-cash benefit based on at least one of:
a number of co-users who repost the message on web pages of their accounts on the social network, or
a number of co-users who provide an indication of approval of the message using their accounts on the social network, wherein the indication of approval can be viewed by other co-users of the social; and
in response to receiving the indication, providing a confirmation message to the user indicating that the non-cash benefit will be provided.

2. The method of claim 1, wherein the non-cash benefit comprises a discount on a product or service provided by the advertiser.

3. The method of claim 1, wherein the non-cash benefit comprises access to at least one of a product, service, or information to which the user did not previously have access.

4. (canceled)

5. The method of claim 1, further comprising:
receiving data relating to the interaction of one or more co-users of the social network with the posted message; and
storing data based on the received data in a memory and providing the advertiser with access to the stored data.

6. The method of claim 5, wherein the non-cash benefit is based at least in part on the data relating to the interaction of one or more co-users of the social network with the posted message.

7. The method of claim 1, wherein performing the one or more actions on behalf of the advertiser comprises storing data relating to the social network of the user in a memory and providing the advertiser with access to the data.

8. The method of claim 7, wherein the data comprises a list of the co-users with which the user is connected in the social network.

9. The method of claim 7, wherein the data comprises profile information associated with the user on the social network.

10. The method of claim 7, wherein the non-cash benefit is based at least in part on the data relating to the account of the user on the social network.

11. The method of claim 10, wherein the non-cash benefit is based at least in part on a number of co-users with which the user is connected through the social network.

12. The method of claim 1, wherein the confirmation message includes information used to access the non-cash benefit.

13. An apparatus comprising:
at least one computing device operably coupled to at least one memory and configured to:
transmit an electronic advertisement to a user computing device, wherein the electronic advertisement includes an invitation for the user to receive a non-cash benefit in return for allowing an advertiser associated with the electronic advertisement to utilize one or more aspects of an account of the user on a social network for the benefit of the advertiser, wherein the social network comprises a service on which the user can post messages, and wherein the social network comprises accounts for each of one or more co-users and the user's account is connected to the accounts of the one or more co-users of the social network;
receive an indication that the user has accepted the invitation for the non-cash benefit;
in response to receiving the indication, perform one or more actions on behalf of the advertiser relating to the account of the user on the social network, wherein the one or more actions comprise causing a message to be posted on a web page of the account of the user on the social network, the message being related to at least one of the advertisement or the advertiser;
determine, using the one or more computing devices, a value for the non-cash benefit based on at least one of:
a number of co-users who repost the message on web pages of their accounts on the social network, or
a number of co-users who provide an indication of approval of the message using their accounts on the social network, wherein the indication of approval can be viewed by other co-users of the social; and
in response to receiving the indication, transmit data to the user that is configured to provide the user with access to the non-cash benefit.

14. The apparatus of claim 13, wherein the non-cash benefit comprises a discount on a product or service provided by the advertiser.

15. The apparatus of claim 13, wherein the non-cash benefit comprises access to at least one of a product, service, or information to which the user did not previously have access.

16. (canceled)

17. The apparatus of claim 13, wherein the at least one computing device is configured to:
receive data relating to the interaction of one or more co-users of the social network with the posted message; and
store data based on the received data in the at least one memory and provide the advertiser with access to the stored data.

18. The apparatus of claim 17, wherein the non-cash benefit is based at least in part on the data relating to the interaction of one or more co-users of the social network with the posted message.

19. The apparatus of claim 13, wherein the at least one computing device is configured to perform at least one of the one or more actions on behalf of the advertiser by storing data relating to the social network of the user in the at least one memory and providing the advertiser with access to the data.

20. The apparatus of claim 19, wherein the data comprises a list of the co-users with which the user is connected in the social network.

21. The apparatus of claim 19, wherein the data comprises profile information associated with the user on the social network.

22. The apparatus of claim 19, wherein the non-cash benefit is based at least in part on the data relating to the account of the user on the social network.

23. The apparatus of claim 22, wherein the non-cash benefit is based at least in part on a number of co-users with which the user is connected through the social network.

24. A computer-readable medium having instructions stored thereon that, when executed by a processor, cause the processor to perform operations comprising:
transmitting an electronic advertisement to a user computing device, wherein the electronic advertisement includes an invitation for the user to receive a non-cash benefit in return for allowing an advertiser associated with the electronic advertisement to utilize one or more aspects of an account of the user on a social network for the benefit of the advertiser, wherein the social network comprises a service on which the user can post messages, and wherein the social network comprises accounts for each of one or more co-users and the user's account is connected to the accounts of the one or more co-users of the social network;
receiving an indication that the user has accepted the invitation for the non-cash benefit;
in response to receiving the indication, performing one or more actions on behalf of the advertiser relating to the account of the user on the social network, wherein the one or more actions comprise causing a message to be posted on a web page of the account of the user on the social network, the message being related to at least one of the advertisement or the advertiser;
determining, using the one or more computing devices, a value for the non-cash benefit based on at least one of a number of co-users who repost the message on web pages of their accounts on the social network and a number of co-users who provide an indication of approval of the message using their accounts on the social network, wherein the indication of approval can be viewed by other co-users of the social network; and
in response to receiving the indication, transmitting data to the user that is configured to provide the user with access to the non-cash benefit.

25. (canceled)

26. The computer-readable medium of claim 24, further comprising:
receiving data relating to the interaction of one or more co-users of the social network with the posted message; and
storing data based on the received data in a memory and providing the advertiser with access to the stored data.

27. The computer-readable medium of claim 26, wherein the non-cash benefit is based at least in part on the data relating to the interaction of one or more co-users of the social network with the posted message.

28. The method of claim 1, wherein the non-cash benefit comprises a discount relating to at least one of the advertiser or a product or service associated with the advertisement, and wherein the value of the discount provided to the user increases as a number of co-users with whom the user is connected through the social network increases.

29. The method of claim 1, wherein the non-cash benefit comprises a discount relating to at least one of the advertiser or a product or service associated with the advertisement, and wherein the value of the discount provided to the user increases as a number of co-users who interact with the posted message increases.

30. The method of claim 1, further comprising transmitting the electronic advertisement to at least one of co-users who repost the message and co-users who provide the indication of approval of the message, wherein the electronic advertisement includes an invitation for the at least one of co-users who repost the message and co-users who provide the indication of approval of the message to receive the non-cash benefit in return for allowing the advertiser to utilize one or more aspects of accounts of the at least one of co-users who repost the message and co-users who provide the indication of approval of the message on a social network for the benefit of the advertiser.
